(19) United States
(12) Patent Application Publication
(10) Pub. No.: US 2020/0070043 A1
(43) Pub. Date: Mar. 5, 2020

(54) MAGNETICALLY ATTRACTIVE LAP DESKS AND METHODS OF MAKING THE SAME

(71) Applicant: Beverly Ann Nance, Stockbridge, GA (US)

(72) Inventor: Beverly Ann Nance, Stockbridge, GA (US)

(21) Appl. No.: 16/531,758

(22) Filed: Aug. 5, 2019

Related U.S. Application Data
(60) Provisional application No. 62/724,883, filed on Aug. 30, 2018.

(51) Int. Cl. A63F 9/10; H01F 13/00

(52) U.S. Cl. CPC A63F 9/1044; A63F 2003/00905; H01F 13/00

(57) ABSTRACT

A method of modifying a non-magnetic surface to become magnetic enables magnetic puzzle pieces to be assembled thereon. The invention also includes the resulting modified article, which may be portable, enabling the magnetic lap desk to be transported from palace to place, including transportation by young children. A magnetic paint or primer is used to convert at least the top surface of the lap desk or other article. A further advantage of the invention is that since a user applies the paint or over-coats, different proprietary colors and/or designs may be achieved.

### REFERENCE TO RELATED APPLICATIONS

This application claims priority to, and the benefit of U.S. Provisional Patent Application Ser. No. 62/724,883, filed Sep. 7, 2018, the entire content of which is incorporated herein by reference.

### FIELD OF THE INVENTION

This invention relates generally to jigsaw puzzles and, in particular, to magnetic jigsaw puzzles and, even more particularly, to a method of modifying a portable lap desk so as to provide a magnetic surface, and the lap desks resulting from such modification.

### BACKGROUND OF THE INVENTION

Jigsaw puzzles were originally created by painting a picture on a flat, rectangular piece of wood, and then cutting that picture into small pieces with a jigsaw, hence the name. John Spilsbury, a London cartographer and engraver, is credited with commercializing jigsaw puzzles around 1760.

Since the invention of the basic jigsaw puzzle, numerous variations have become available, including magnetic jigsaw puzzles, wherein the pieces include a magnet or, more typically, each piece includes a layer of magnetic material. Even magnetic puzzles have been known for many years. U.S. Pat. No. 2,002,077, which dates back to the 1930s, describes a magnetic puzzle wherein the puzzle pieces or elements are composed wholly or partially of magnetic material to permit their placement and arrangement on a magnetized plate to facilitate the supporting of the puzzle elements on the plate against displacement with respect to each other. A further object is to provide a magnetized plate or table, and a tool such as a suction cup for lifting and transporting the puzzle elements to and from the plate or table.

Today there are many magnetic surfaces to choose from, including metal surfaces such as refrigerator doors (if they are not pure stainless steel). It is now popular to affix refrigerator magnets and magnetic puzzles to refrigerator doors, with the advantage being that the arrangement is generally undisturbed between changes.

There are also magnetic puzzle plates available for magnetic puzzle mounting; for example, a sheet of iron-containing metal such as steel may be used for such purpose. However, there are currently no described methods for transforming an existing, non-magnetic surface into a magnetic surface for magnetic puzzle assembly.

### SUMMARY OF THE INVENTION

This invention solves the problems associated with the existing art by providing a method of modifying a non-magnetic surface to become magnetic, thereby enabling magnetic puzzle pieces to be assembled thereon. The invention also includes the resulting modified article.

In the preferred embodiment, the invention is used to modify an existing wood or faux wood laptop-type desk. One advantage of the invention is that the resulting article is portable, enabling the magnetic lap desk to be transported from palace to place, including transportation by young children.

In accordance with the invention, a so-called “magnetic paint” is used to convert at least the top surface of the lap desk or other article. A further advantage of the invention is that since a user applies the paint, different colors and/or designs may be achieved.

### BRIEF DESCRIPTION OF THE DRAWINGS

FIG. 1 shows a lap desk to which the invention is applicable.

### DETAILED DESCRIPTION OF THE PREFERRED EMBODIMENTS

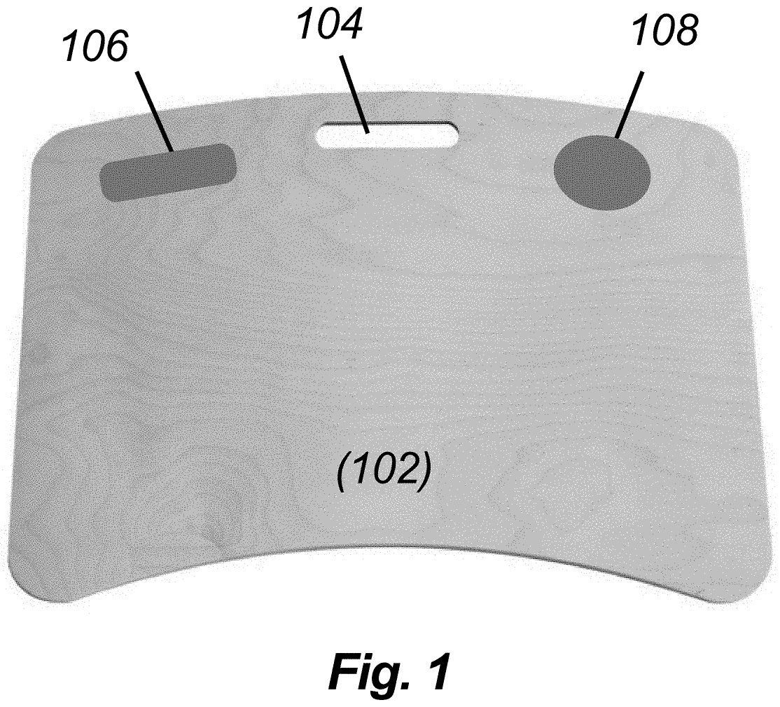

Now making reference to the accompanying drawing, FIG. 1 depicts simple lap desk 102 to which the invention is applicable. The item may include an optional through-handle 104 and one or more optional trays 106, 108. While this particular item is a flat board made from wood, the invention is not limited in this regard, and may be used with other styles of lap desks including desks with different shapes, side legs, and integral trays to hold accessories. If a tray is presented, it may or not be painted with magnetic paint at the preference of the user. Further, while the item shown is unfinished wood, other materials may be used such as finished wood, faux wood and certain plastics if the appropriate primer is used.

Magnetic paints are not actually “magnetic”; rather, in addition to pigment, magnetic paints include iron particles so that the resultant surface is attractive to magnetic items, including magnetic puzzle pieces. When applied to a surface, the result is a layer of dark primer with many tiny flecks of iron spread throughout. Magnets are attracted to these bits and pieces of iron.

Suitable magnetic paints are available from Rust-Oleum® and other sources. For example, Rust-Oleum sells a dark gray magnetic primer that can be used to convert many indoor surfaces into a custom magnet board. The product works on wood, metal, masonry, drywall and plaster, and may be top-coated with any latex, dry erase or chalkboard paint.

In addition to commercially available magnetic paints, non-magnetic paint may be made magnetic through the inclusion of iron powder. Regardless of how the magnetic paint is provided, very thorough mixing is important. Left alone on the shelf, the iron particles will tend to settle to the bottom. The product should be mixed thoroughly to ensure the layer of paint has iron particles spread throughout. More layers of the magnetic primer increase the magnetic attraction effect and conversely, too many top coats may reduce the magnetic attraction effect.

In accordance with the invention, at least the top surface of a commercially available lap desk is painted with one or more coats of magnetic paint or primer. These layer(s) may then optionally be covered with one or more top coats to achieve a desired appearance and/or effect.

1. A method of transforming an article into a magnetically attractive article, comprising the steps of:
providing a lap desk having an upper surface;
applying one or more coats of magnetic paint or primer to the upper surface of the lap desk; and
allowing the one or more coats of magnetic paint or primer to dry.

2. The method of claim 1, including the steps of:
providing a magnetic jigsaw puzzle having a plurality of magnet pieces; and
assembling the magnetic jigsaw puzzle on the coated surface of the lap desk.

3. The method of claim 1, wherein the lap desk is made of wood.

4. The method of claim 1, wherein at least the surface of the lap desk is made of a faux wood.

5. The method of claim 1, wherein:
the upper surface of the lap desk includes one or more trays; and
avoiding the one or more trays with the one or more coats of magnetic paint or primer.

6. The method of claim 1, further including the step of applying one or more top coats over the one or more coats of magnetic paint or primer to achieve a desired appearance.

7. A lap desk modified in accordance with the method of claim 1.

8. A lap desk modified in accordance with the method of claim 3.

9. A lap desk modified in accordance with the method of claim 5.

10. A lap desk modified in accordance with the method of claim 7.
